(19) United States
(12) Patent Application Publication
(10) Pub. No.: US 2004/0005913 A1
(43) Pub. Date: Jan. 8, 2004

(54) Multiband terminal

(76) Inventor: Jan Bollenbeck, Eggolsheim (DE)

Correspondence Address: BELL, BOYD & LLOYD, LLC, P. O. BOX 1135, CHICAGO, IL, 60690-1135, US

(21) Appl. No.: 10/399,935

(22) PCT Filed: Sep. 20, 2001
(86) PCT No.: PCT/DE01/03643

(30) Foreign Application Priority Data
Oct. 24, 2000 (DE) 10052711.6

(51) Int. Cl. H04M 1/00; H04B 1/38

(52) U.S. Cl. 455/562.1; 455/561; 455/550.1

(57) ABSTRACT

A multiband terminal is provided which operates in at least two frequency bands, wherein the terminal includes one transmit device and one receive device for each of the frequency bands, and further includes at least two antennas and one circuit arrangement for connecting the antennas with the transmit devices and/or the receive devices, the circuit arrangement being designed such that, at least for one of the frequency bands and during operation of such, the associated receive device is switched to a first of the antennas as a receive antenna and the associated transmit device is switched to a second of the antennas as a transmit antenna.

The invention relates to a multiband terminal that operates in at least two frequency bands, with at least one transmitting device and at least one receiving device for each of the frequency bands, with at least two antennas and with circuit arrangement to connect the antennas with the transmitting devices and/or the receiving devices.

In the development of multiband terminals, multiband mobile radio telephones for example, the problem arises of switching a number of transmitting and receiving devices to one antenna system. It is previously known here that the relevant transmitting devices and receiving devices that are provided for different frequency devices can be operated via a single common antenna. Also known is the use of different antennas for various frequency bands and the of the transmitting device and the receiving device of the frequency band at the individual antennas in each case.

With mobile radio standards such as GSM or DCS this type of injection of the transmitting and receiving device at the same antenna is not a problem, since such systems operate in what is known as “half-duplex mode” whereby the system alternately either transmits or receives. It is therefore possible to couple the transmitting device and the receiving device via a relatively simple changeover switch that switches backwards and forwards between the two devices in the appropriate way.

By contrast it is more difficult to couple transmitting and receiving devices in a mobile radio standard such as UMTS for example, in which operation is in “full-duplex mode”, i.e. in which the transmitter and receiver are active simultaneously. With systems of this type it must be ensured that there is sufficient decoupling of the transmitting path from the receiving path. Conventionally this is achieved by a very high quality and thus very expensive duplex filter. As well as its function of merging the receiving path and the transmitting path in an antenna path with the correct impedance, the task of the duplex filter is to keep the transmit payload signal as well as the noise created from the transmitting path in the receiving path away from the input of the receiving device. This filter thus features relatively high attenuation in the pass bands in orders of magnitude of 1.5 to 2.0 db in the transmitting range and 2.0 to 2.5 db in the receiving range. The attenuation in the transmitting path is reflected in both increased power consumption of the transmitter as well as in higher system costs, since the final stage in the transmitting path must be designed for a higher output power level by the amount of the attenuation. Likewise the increased power consumption must be taken into consideration in the dimensioning of the power supply for the final stage and sufficient dissipation of the waste heat must be ensured. Improved dissipation of waste heat is as a rule linked with a greater device volume which runs counter to the requirement for miniaturization of the devices.

In the receiving path the attenuation goes directly into the noise figure or the sensitivity of the receiver. Here too compensating for the adverse effects of the attenuation leads to increased system costs.

Additional attenuation is also caused by the switches or frequency dividers required for the coupling, that bring about the coupling of the individual function groups to the relevant antennas.

The task of the present invention is thus to create a multiband device of the type mentioned in the introduction that features a lower-attenuation connection of the receiving devices and the transmitting devices to the antennas.

This problem is resolved by a multiband terminal in accordance with patent claim 1. The dependent claims include particularly advantageous developments and embodiments of the invention.

With the multiband terminal in accordance with the invention the design of the circuit arrangement is such that, at least for one of the frequency bands, during operation in this frequency band, the associated receiving device is switched to the first of the antennas as receiving antenna and the associated transmitting device is switched to a second antenna as a transmitting antenna. Since for this frequency band the transmitting device and the receiving device each feature separate antennas, operation in full-duplex mode is also possible in this frequency band, in which case it is possible to dispense with an expensive duplex filter. Simple, separate filters can be used for the transmitting and receiving path. The spatial separation of the antennas also means that the transmitting and receiving device are additionally decoupled for the frequency band involved, so that the requirements for selection by the transmit filter in the relevant frequency band are significantly less than with the conventional coupling procedure. Overall this minimizes the attenuations in the interface between the transmit and the receiving devices as well as the antenna system, which is directly linked to lower production costs for this type of multiband terminal as well as with a better quality of transmission. To achieve the greatest possible decoupling, the antennas are preferably designed in such a way that that the polarization planes of the transmitting and receiving antenna lie orthogonally in relation to each other.

With a preferred exemplary embodiment the terminal features a changeover switch that is connected to one of the antennas which serves as the receive antenna and which through connects the receiving antenna to the receiving devices for the different frequency bands in each case.

The different transmitting devices for the individual frequency bands are then for example switched via a filter device to a second of the antennas which serves as a common transmitting antenna. This filter device can also be designed in a number of stages or from a number of filter devices connected in series. Likewise the filter device, or individual devices within a chain of filter devices, can also be designed variably, i.e. that the relevant filter device features means for setting the filter frequency.

In another preferred exemplary embodiment a number of the transmitting devices operating in different frequency bands are switched to a common final stage, in which case the final stage also preferably features means for switching over the operating mode for the different frequency bands, i.e. it is possible to select for example whether the final stage operates in what is known as “AB mode” (linear mode) or in C mode, depending on whether operation favors the transmission procedure used in the relevant frequency band. In addition coupling of different frequency bands via shared final stages and the filter devices connected downstream from them is possible.

With a particularly preferred exemplary embodiment the terminal device features, in addition to the internal antennas, an antenna output for connecting an external antenna, for the antenna of a handsfree device in a vehicle for example. The terminal also features an internal/external changeover switch to switch between one of the antennas of the terminal and the antenna output. The switch here is preferably made between an antenna of the terminal used as transmitting antenna and the antenna connection. This is specifically advantageous for operation in a vehicle in order to keep the field strength in the passenger compartment low for reasons of personal protection and of EMC protection of the vehicle electronics. The receivers in this operating case are fed onwards to an external transmit antenna via the device's own antenna. There is no serious disadvantage to this in practice, since the cable attenuation of the vehicle antennas currently commercially available largely negates the benefit produced by the freestanding vehicle antenna as opposed to the device antenna in the interior of the vehicle.

The invention is described in more detail below with reference to the enclosed drawings using exemplary embodiments. The features illustrated below and the features already described above cannot just be used in the given combinations, but also individually or in other combinations largely along the lines of the invention. The figures show the following:

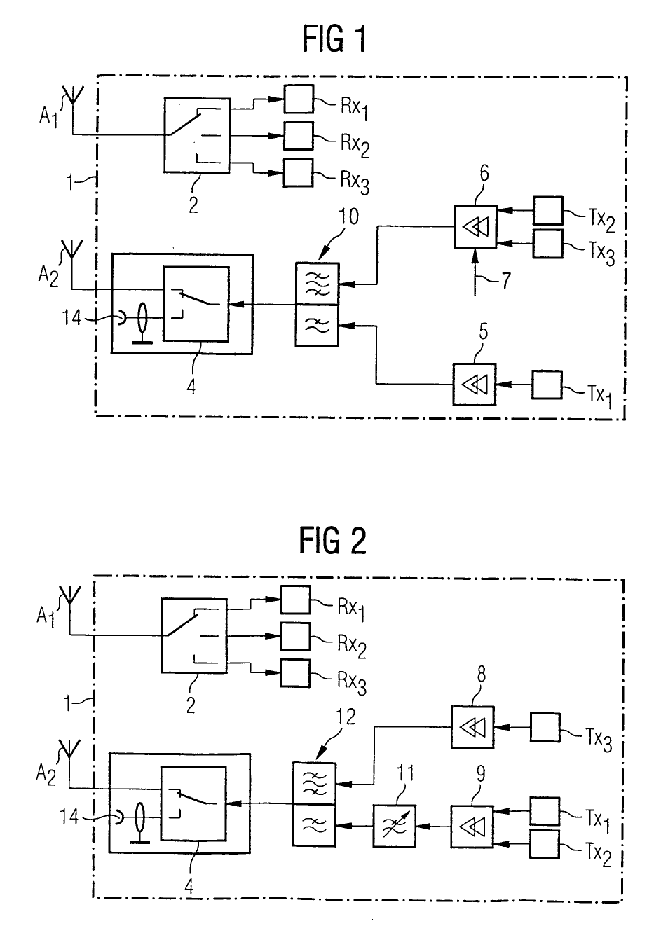

FIG. 1 a schematic block diagram of the circuit arrangement of a multiband terminal in accordance with the first exemplary embodiment,

FIG. 2 a schematic block diagram of the circuit arrangement of a multiband terminal in accordance with a second exemplary embodiment,

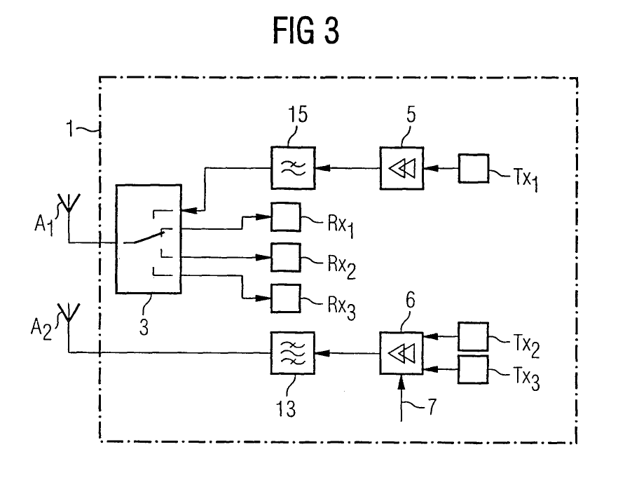

FIG. 3 a schematic block diagram of the circuit arrangement of a multiband terminal in accordance with a third exemplary embodiment.

The block diagrams represented in the figures show the major function blocks within the mobile radio device for the arrangement in accordance with the invention. Naturally the mobile radio device also contains the other usual functional units.

With all of the exemplary embodiments described below, the starting point is a multiband mobile radio device, that operates in a first frequency band in half-duplex mode, in a second frequency band in half or full-duplex mode and in a third frequency band in full duplex mode.

A typical example of this is a multiband terminal that operates in the EGSM system, in the DCS system and in the UMTS system. The GSM system and also the DCS system operate in half-duplex mode, the UMTS system operates in full-duplex mode.

The positions of the relevant frequency bands of the individual transmit and receiving devices are as follows:

| System | transmit band | receive band |
|---|---|---|
| EGSM | 0.880 to 0.915 GHz | 0.925 to 0.960 GHz |
| DCS | 1.710 to 1.785 GHz | 1.805 to 1.880 GHz |
| UMTS | 1.920 to 1.980 GHz | 2,110 to 2.170 GHz |

In the exemplary embodiment shown in FIG. 1 the two antennas A₁ and A₂ in the mobile device are divided up into a receive antenna A₁ and a transmit antenna A₂.

In this embodiment, at least one of the two antennas can be integrated into the device as a PCB (Printed Circuit Board) antenna or patch antenna. Preferably this is receive antenna A₁, since with a freestanding transmit antenna changes to the adaptation to the final stage output of the transmitting device because of shadowing—e.g. by a hand placed in front of the antenna integrated into the mobile radio device are minimized. The other antenna A₂ for example can typically be a stub antenna or such like integrated into or onto the device. It is also possible to integrate both antennas into the housing as PCB or patch antennas or similar.

The first antenna A₁ which serves as the receive antenna is connected here via a three-way changeover switch 2 to receiving devices Rx₁, Rx₂, Rx₃ for the three frequency bands.

The second device-own antenna A₂ is connected on the input side via an internal/external changeover switch 4 with an antenna output 14 for connecting an external antenna. The Internal/external changeover switch 4 is preferably a mechanical switch integrated into the antenna jack or in antenna output 14 that switches over automatically when a plug is inserted into the antenna socket. The transmitting paths for all three frequency bands are routed via a frequency divider, for example a diplex filter, at the input of the internal/external changeover switch 4. In this case a transmit filter for the frequency band operating in duplex mode, e.g. a low-pass or notch filter, with which the transmit noise in the associated receive band can be filtered, can be advantageously integrated into the diplex filter. This is illustrated in FIG. 1 by showing two filters as a common block of a filter device 10. Transmit devices Tx₂, Tx₃ for the second and third frequency band, for the present exemplary embodiment of the DCS and the UTMS frequency band, operate with a common dual band final stage 6. Via a switched input 7 the operating mode for a change of band can be switched from AB mode (linear mode) to C mode. This is useful since in the GSM or DCS system what is known as GMSK modulation with a constant envelope is used. This means that the modulated RF signal has a constant amplitude. Thus no signal distortions can occur as a result of a non-linear amplifier characteristic curve. It is therefore not necessary for the final stage to have a linear characteristic curve in these bands. Therefore C mode can be used to increase the efficiency. In the UMTS system on the other hand an HPSK modulation with a non-constant envelope is used. This system thus requires linear operation of the power amplifier so that operation must be in AB mode.

In the exemplary embodiment in accordance with FIG. 2 the first antenna is only used as a transmit antenna for all three frequency bands, as it is in the exemplary embodiment in accordance with FIG. 1. The same changeover switch 2 can be used, to switch antenna A₁ to receiving devices Rx₁, Rx₂, Rx₃ of the three frequency bands.

In contrast to the exemplary embodiment in accordance with FIG. 1 however, a monoband linear final stage 8 is used here for transmitting device Tx₃ of the third frequency band (here the UMTS system), which operates in the full-duplex system. Instead the transmitting devices Tx₁ and Tx₂ for the other two frequency bands (here EGSM and DCS) are directed to a common dual band final stage 9. The output of the dual band final stage 9 is initially switched to an adjustable filter device 11. This takes the form of a switchable lowpass filter with which the first transmit harmonic can be suppressed in the GSM operating case. The limit frequency here can be varied in such a way that the DCS fundamental wave in the DCS operating case can be passed unattenuated. Subsequently the output of monoband final stage 8 for the third frequency band and the output of the switchable lowpass filter 11 are directed to a further filter device 12. This filter device 12 in its turn features a diplex filter as a frequency divider with an integrated lowpass or notch filter as transmit filter for the UMTS frequency band.

Here too in the exemplary embodiment in accordance with FIG. 1 the output of the last filter device 12 is again routed to an internal/external changeover switch 4 to switch between the device-own second antenna A₂ and an antenna output 14 for an external antenna, for example a vehicle antenna.

The third exemplary embodiment in accordance with FIG. 3 is particularly suited to mobile radio devices that are not intended for operation at an external antenna, for example in a vehicle.

Here too, in accordance with the invention, the device's own antennas A₁, A₂ are used as separate transmit and receive antennas for operation in those frequency bands that operate in full duplex mode.

In the arrangement shown, instead of three-way changeover switch 2, a four-way changeover switch 3 is used to connect the first antenna 1, in which case in addition to the three receiving devices Rx₁, Rx₂, Rx₃ for the three frequency bands, the transmitting device Tx₁ is now switched via a final stage 5 and a filter device 15 to the first antenna A₁. Consequently antenna A₁ is used for operation in this frequency band as transmit as well as receive antenna, by using four-way changeover switch 3 to permanently switch backwards and forwards between receiving device Rx₁ and transmitting device Tx₁ of the relevant frequency band, in this case the EGSM system.

The second antenna A₂ of the device then only serves as a transmit antenna for the second and third frequency band, i.e. in the present exemplary embodiment for the DCS and the UMTS system. To this end transmitting devices Tx₂ and Tx₃ of the second and third frequency band are in their turn switched to a dual band final stage 6 that can be set via a switched input 7 to the different operating modes for the two frequency bands. The output of this dual band final stage 6 is then routed through a filter device 13 to the antenna input of the second antenna A₂. This type of DCS/UMTS dual band antenna can be implemented in a relatively easy and space-saving way because of the adjacent frequency range around 1.8 GHz as a PCB antenna or patch antenna.

The invention is of course not restricted to the exemplary embodiments shown here, there are various further options for decoupling the transmit and receiving devices on the relevant antennas in accordance with the invention. Likewise antenna systems can of course be connected with more than two antennas as well as terminals with only two (dual band mode) or with more than three different frequency bands in accordance with the invention. An example for a dual band terminal in accordance with the invention is a structure as shown in FIG. 3, whereby four-way changeover switch 3 is merely replaced by a two-way changeover switch and must switch backwards and forwards between the two receiving devices for the two frequency bands, i.e. the first antenna A₁ in this case serves in its turn only as a pure transmitting antenna.

1. Multiband terminal which operates in at least two frequency bands, with one transmit device (Tx₁, Tx₂, Tx₃) and one receive device (Rx₁, Rx₂, Rx₃} for each of the frequency bands, with at least two antennas (A₁, A₂) and with one circuit arrangement (1) for connecting the antennas with the Transmit devices {Tx₁, Tx₂, Tx₃) and/or the receive devices {Rx₁, Rx₂, Rx₃} characterized in that the circuit arrangement is designed in such a way that at least for one of the frequency bands during operation in this frequency band the associated receive device (Rx₂, RX₃} is switched to a first of the antennas (A₁) as receive antenna and the associated transmit device (Tx₂, Tx₃) is switched to a second of the antennas (A₂) as transmit antenna.

2. Terminal in accordance with claim 1, characterized by a changeover switch (2, 3) which features an input that is connected to a first of the antennas (A₁) as a receive antenna and which features a number of outputs that are connected to the receive devices {Rx₁, Rx₂, Rx₃} for the different frequency bands.

3. Terminal in accordance with claim 2, characterized in that changeover switch (3) features a further output that is connected to a transmit device (Tx₁) of at least one of the frequency bands, and that in operation the terminal in this frequency band uses the first antenna (A₁) alternately as transmit and receive antenna.

4. Terminal in accordance with one of the claims 1 to 3, characterized in that a number of the transmit devices (Tx₁, Tx₂, Tx₃) operating in the different frequency bands are switched via a filter device (10, 11, 12, 13) to a second of the antennas {A₂) as a common transmit antenna.

5. Terminal in accordance with claim 4, characterized by a number of filter devices (11, 12} connected in series.

6. Terminal in accordance with claim 4 or 5, characterized in that the filter device (10) features means for setting the filter frequency.

7. Terminal in accordance with one of claims 1 to 6, characterized in that a number of the transmit devices (Tx₁, Tx₂, Tx₃) operating in the different frequency bands are switched to a common final stage (6, 9).

8. Terminal in accordance with claim 7, characterized in that the final stage (6) features means (7) for switching over the operating mode for different transmission procedures.

9. Terminal in accordance with one of claims 1 to 8, characterized in that the device is constructed in such a way that it operates in a first frequency band in half-duplex mode and operates in a second frequency band in half-duplex or in full-duplex mode and operates in a third frequency band in full-duplex mode.

10. Terminal in accordance with claim 9, characterized in that a first antenna (A₁) of the device is coupled via a three-way changeover switch (2) with the receive devices (Rx₁, Rx₂, Rx₃) for the first, the second and the third frequency band and the transmit devices (Tx₂, Tx₃) for the second and third frequency band are coupled via a common switchable final stage (6) and an output of this switchable final stage (6) is coupled with an output of a final stage (5) for the transmit device (Tx₁) of the first frequency band via a filter device (10) and is routed to a second antenna (A₂).

11. Terminal in accordance with claim 9, characterized in that a first antenna (A₁) of the device is coupled via a three-way changeover switch (2) with the receive devices (Rx₁, Rx₂, Rx₃) for the first, the second and the third frequency band and the transmit devices (Tx₂, Tx₃) for the second and third frequency band are coupled via a common final stage (9) and are routed via a switchable filter device {11) and an output of this switchable filter device is coupled with a output of a final stage (8) for transmit device (Tx₃) of the third frequency band via a filter device (12) and routed to a second antenna (A₂).

12. Terminal in accordance with claim 9, characterized in that a first antenna (A₁) of the device is connected via a four-way changeover switch (2) with the receive devices (Rx₁, Rx₂, Rx₃) for the first, the second and the third frequency band and with a transmit device (Tx₁) for the first frequency band, and the four-way changeover switch (3) during operation in the first frequency band constantly switches backwards and forwards between the receive device (Rx₁) and the transmit device (Tx₁) for the first frequency band and the transmit devices (Tx₂, Tx₃) for the second and third frequency band are coupled via a common, switchable final stage (6) and an output of this switchable final stage (6) is routed via a filter device (13) to a second antenna (A_{Z}).

13. Terminal in accordance with one of the claims 1 to 12, characterized by an antenna output (14) for connecting an external antenna and an internal/external changeover switch (4) for switching between one of the antennas (A₂} of the terminal and the antenna output (14).

14. Terminal in accordance with claim 13, characterized in that the internal/external changeover switch (4) switches between the second antenna (A₂) of the terminal serving as the transmit antenna and the antenna connection (14).
